(19) United States
(12) Patent Application Publication
(10) Pub. No.: US 2007/0298300 A1
(43) Pub. Date: Dec. 27, 2007

(54) FUEL CELL DEVICE WITH CHARGER FUNCTION

(76) Inventors: HSI-MING SHU, Taipei (TW); Ko Chen Shen, Taipei (TW); Tsang-Ming Chang, Taipei (TW); Wei-Li Huang, Taipei (TW); Feng-Yi Deng, Taipei (TW); Chih-Jung Kao, Kaohsiung (TW); Ming-Huang Tsai, Kaohsiung (TW); Chun-I Pan, Kaohsiung (TW); Chien-An Chen, Kaohsiung (TW); Wen Jui Chuang, Kaohsiung (TW)

Correspondence Address: G. LINK CO., LTD., 3550 BELL ROAD, MINOOKA, IL, 60447, US

(21) Appl. No.: 11/767,536

(22) Filed: Jun. 25, 2007

(30) Foreign Application Priority Data
Jun. 26, 2006 (CN) 200620114893.3

(51) Int. Cl. H01M 8/04

(52) U.S. Cl. 429/26; 429/34; 429/23

(57) ABSTRACT

The present invention discloses a fuel cell device with charger function, which comprises a base, a fuel cell stack, a system fan, a wind cover, a display, a circuit board, a condenser structure, a condensing fan, a mixing tank and a pump. The fuel cell device could not only supply the power to various electronic products for usage and provide with the charger function, but also could charge different electronic products anytime and anywhere to realize the mobile charging idea.

### FIELD OF THE INVENTION

The present invention relates to a fuel cell device, and particularly to a fuel cell device providing self generation and with the function of mobile charging.

### BACKGROUND OF THE INVENTION

The fuel cell could provide various features, such as extremely long operation time, without charging, low pollution, and low noise, and has been treated as a new generation of energy technology when the energy saving and environmental protection issues have been emphasized worldwide. Currently, a lot of high technology companies have worked hard to develop a micro fuel cell device to replace the existing batteries as the power source for portable electronic products. Unfortunately, the fuel cell device provided by each manufacturer could only be applied for a specific power consumption apparatus, but not suitable for other brands, or other types of power consumption apparatus for use. Secondly, the conventional fuel cell device could not provide the functions as a charger, and it still needs to combine with the independent power from the power consumption apparatus itself, and rely on the associated facilities, such as water management and heat management, provided by the power consumption apparatus itself, so as to keep the power supply from breaking down. Thus, the conventional fuel cell devices not only have the above-mentioned defects, but also have a large development space to work on.

The inventor of the present invention has been in view of the conventional defects, and worked for the improvement to disclose a fuel cell device with charger function, which could not only have self-generation and supply the electricity to various electronic products for operation, but also could function as a charger for various electronic products.

### SUMMARY OF THE INVENTION

The main object of the present invention is to provide a fuel cell device, which could not only supply the power to various electronic products for usage and provide with the charger function, but also could charge different electronic products anytime and anywhere to realize the mobile charging idea.

To this end, the present invention provide a fuel cell device with charger function, which comprises: a base; a fuel cell stack, which is fixed at the base; at least one cathode fuel inlet, which is configured at the end of the upper surface of the fuel cell stack; a system fan, which is configured on the first side of the fuel cell stack; a wind cover, in which one end of the wind cover is tightly coupled with the first side of the fuel cell stack, and the other end of the wind cover is tightly coupled with the system fan; a display, which is configured on the second side of the fuel cell stack; a circuit board, which is vertically fixed with the base, and configured on the third side of the fuel cell stack; a condenser structure, which is configured on the fourth side and on the upper surface of the fuel cell stack, and the inlet of the condenser structure is coupled with the system fan; a condensing fan, which is tightly fixed on one side of the condenser structure; a mixing tank, which is tightly coupled with the side of the condenser structure on the same side of the condensing fan, and the mixing tank is connected to the anode fuel inlet of the fuel cell stack and the condenser structure with pipes, respectively; and, a pump, which is tightly configured on one side of the mixing tank.

### BRIEF DESCRIPTION OF THE DRAWINGS

The present invention would be detailed described in the following to make the skilled in the art further understand the objects, features and advantages of the present invention with the embodiments and the attached figures, wherein:

FIG. 1 is a three-dimensional appearance view of the fuel cell device according to the present invention;

FIG. 2A is a front view and a partial perspective view of the internal assembly structure of the fuel cell device according to the present invention;

FIG. 2B is a rear view of the internal assembly structure of the fuel cell device according to the present invention;

FIG. 2C is a three-dimensional exploded diagram of the fuel cell device in FIG. 2A; and

FIG. 3 is a layout diagram for the internal pipes of the fuel cell device according to the present invention.

### DETAILED DESCRIPTION OF THE INVENTION

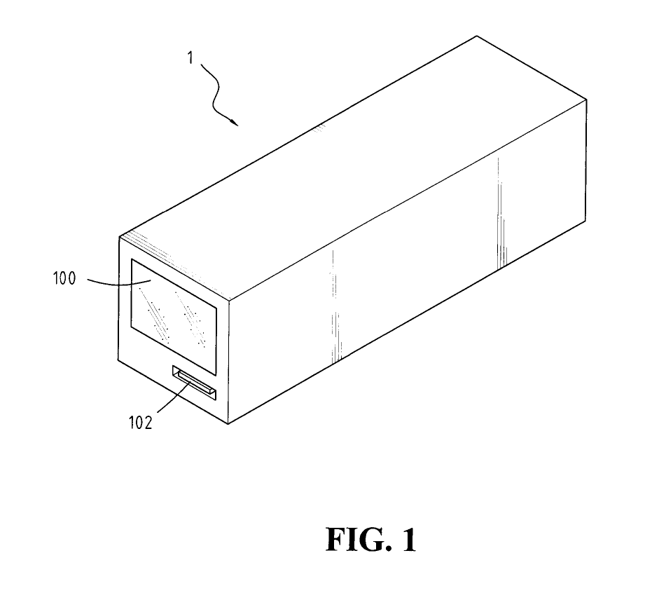

FIG. 1 is a three-dimensional appearance view of the fuel cell device according to the present invention. The fuel cell device 1 according to the present invention could be used as a charger. As shown in FIG. 1, from the appearance, the fuel cell device 1 at least comprises a display 100 and a connection interface 102; in which, the connection interface 102 is at least used as an output for the power generated by the fuel cell stack in the fuel cell device 1, and is used to connect with an electronic device, such as notebook computer, mobile phone, personal digital assistant (PDA), or any kind of portable electronic machine, and the means for the connection interface 102 could employ various electrical connection to realize, such as the conventional universal serial bus (USB) or cable. Also, the connection interface 102 could comprise a connection terminal for outputting different levels of voltage, such as 5V, 9V, 12V or 17V to the electronic device for usage. Furthermore, the display 100 according to the present invention could display various electric messages in the operation for the fuel cell device 1, for example, the messages for insufficient power, saturation, or failure removal. And, the display 100 in the present invention is suitable to employ a compact liquid crystal display (LCD).

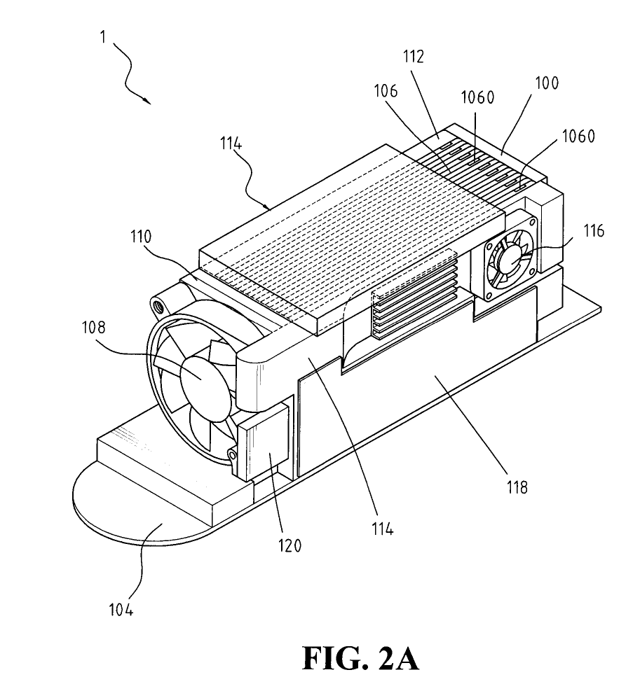

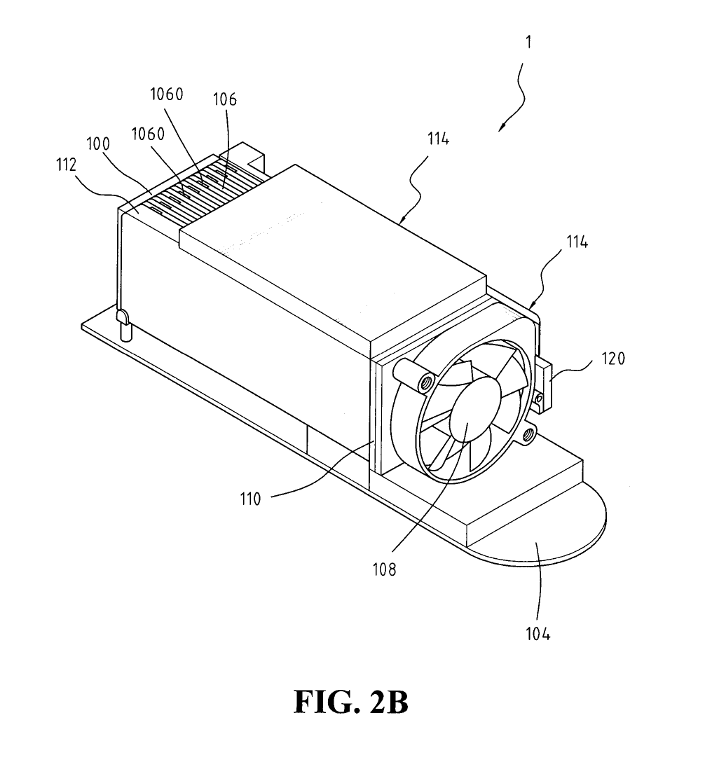

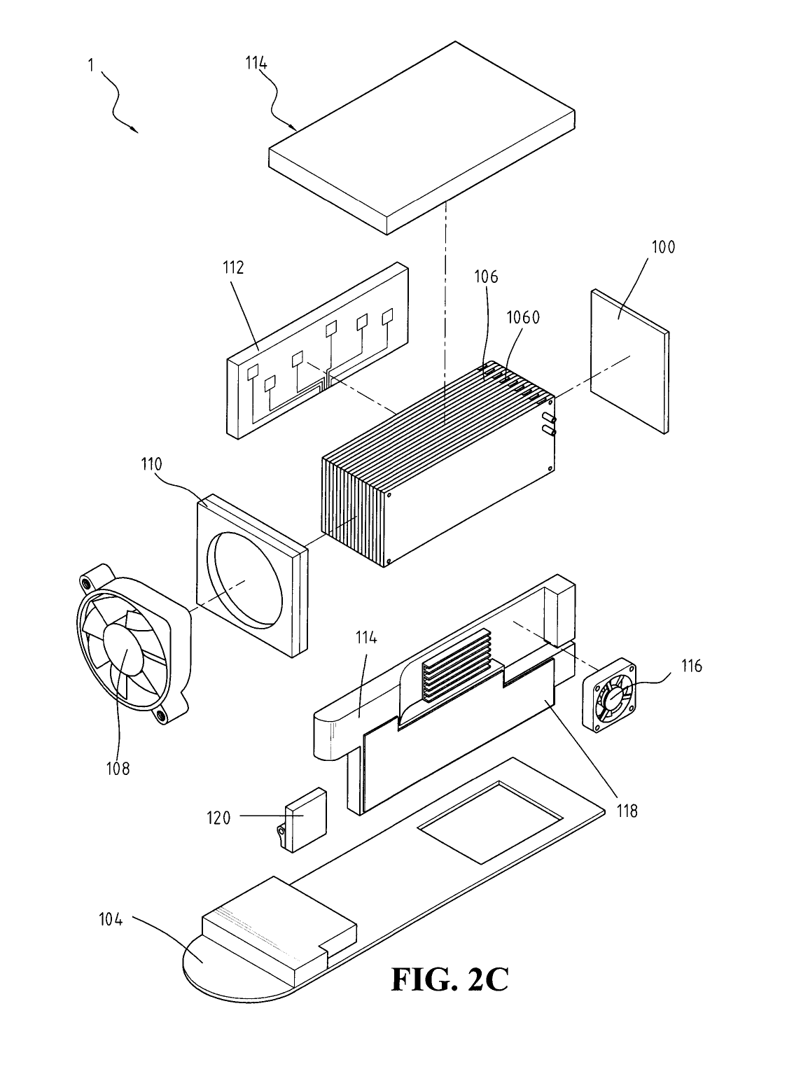

FIG. 2A is a front view and a partial perspective view of the internal assembly structure of the fuel cell device according to the present invention. FIG. 2B is a rear view of the internal assembly structure of the fuel cell device according to the present invention. FIG. 2C is a three-dimensional exploded diagram for the fuel cell device in FIG. 2A. As shown in FIG. 2A and FIG. 2B, the fuel cell device 1 according to the present invention comprises: a display 100, a base 104, a fuel cell stack 106, a system fan 108, a wind cover 110, a circuit board 112, a condenser structure 114, a condensing fan 116, a mixing tank 118, and a pump 120.

The internal configuration for these components in the fuel cell device 1 would be described in details. First, the fuel cell stack 106 is fixed with the base 104, and the cathode fuel inlets 1060 as the air inlets are configured at the end of the upper surface of the fuel cell stack 106. As shown in FIG. 2A, the fuel cell stack 106 is presented as a rectangular cylinder in appearance. The system fan 108 is configured on the first side of the fuel cell stack 106, and provided with the function to introduce the air from the cathode fuel inlets 1060 to the reaction area inside the fuel cell stack 106. One end of the wind cover 110 is similarly tightly coupled with the first side of the fuel cell stack 106, and the other end of the wind cover 110 is tightly coupled with the system fan 108. With the configuration of the wind cover 110, it could effectively improve the performance for introducing air into the fuel cell stack 106 by the system fan 108. The display 100 is configured on the second side of the fuel cell stack 106. The circuit board 112 is vertically fixed with the bas 104, and configured on the third side of the fuel cell stack 106. The fuel cell device 1 according to the present invention further comprises at least on circuit component, wherein these circuit components are configured on the circuit board 112, and the circuit components are electrically connected with the fuel cell stack 106. These circuit components could be used to establish a power management circuit, so that the power generated by the fuel cell stack 106 could be matched with the power required by the electronic device.

Next, the condenser structure 114, the condensing fan 116, the mixing tank 118 and the pump 120 would be described. As shown in FIG. 2A, the condenser structure 114 is configured on the upper surface of the fuel cell stack 106, and configured on the fourth side of the fuel cell stack 106, and the inlet of the condenser structure 114 is coupled with the system fan 108. As for the direct methanol fuel cell (DMFC), the condenser structure 114 is used to condense the steam from the system fan 108 into a liquid water. Of course, the recycled condensing water could be used by the fuel cell again. The condensing fan 116 is tightly fixed with one side of the condenser structure 114, with the function to enhance the condensing effect of the condenser structure 114. The mixing tank 118 is tightly coupled with the side of the condenser structure 114 on the same side of the condensing fan 116, and the mixing tank 118 is connected with the anode fuel inlet of the fuel cell stack 106 and the condenser structure 114 with pipes, respectively. As for the direct methanol fuel cell, the mixing tank 118 is used to store the methanol aqueous solution. The pump 120 is tightly configured on one side of the mixing tank 118, and usually employs a kind of dosing pump as the embodied component.

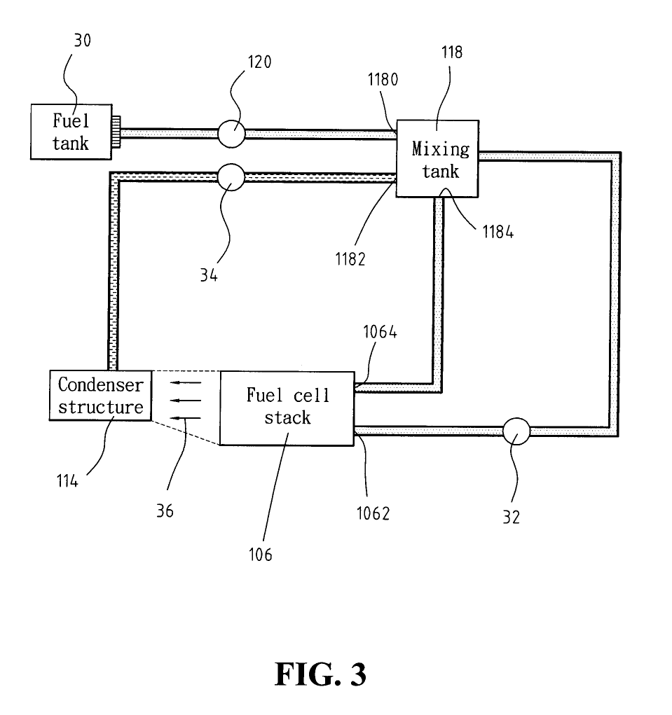

FIG. 3 is a layout diagram of the internal pipes of the fuel cell device 1 according to the present invention. As shown in FIG. 3, the pump 120 is connected between the mixing tank 118 and an external fuel tank 30 with pipes for pulling the fuel in the fuel tank 30 into the first inlet 1180 of the mixing tank 118; wherein, the fuel tank 30 is usually used to store high density fuel. As for the direct methanol fuel cell, the fuel tank 30 is used to store the pure methanol. Moreover, the fuel cell device 1 further comprises: a first pump 32 and a second pump 34; wherein, the first pump 32 is connected between the mixing tank 118 and the fuel cell stack 106 with pipes for pulling the fuel in the mixing tank 118 into the anode fuel inlet 1062 of the fuel cell stack 106; and, the second pump 34 is connected between the mixing tank 118 and the condenser structure 114 with pipes for pulling the condensing water generated from the condenser structure 114 into the second inlet 1182 of the mixing tank 118. As for the condensing water generated by the condenser structure 114, it is mainly condensed by cooling and heat dissipation from the steam 36 generated by the fuel cell stack 106. Furthermore, the anode fuel outlet 1064 of the fuel cell stack 106 in the fuel cell device 1 according to the present invention is also connected with the third inlet 1184 of the mixing tank 118 with pipes, so that the fuel without complete reaction in the fuel cell stack 106 could be recycled back to the mixing tank 118.

The fuel cell device 1 with charger function according to the present invention could have self-generation, and provide with water management and heat management mechanism by itself, which is particularly suitable for application during a trip and for the area without public electricity system, and becomes the advantage of the present invention.

The present invention have been described in details with the preferred embodiments as above, and these disclosed embodiments are not used to limit the scope of the present invention. The skilled in the art could have some changes and modification without departing from the spirit and scope of the present invention, and these changes and modification are still belonged to the attached claims of the present invention.

What is claimed is:

1. A fuel cell device with charger function, which comprises:
a base;
a fuel cell stack, which is fixed with the base, and at least one cathode fuel inlet is configured at the end of the upper surface of the fuel cell stack;
a system fan, which is configured on the first side of the fuel cell stack;
a wind cover, in which one end of the wind cover is tightly coupled with the first side of the fuel cell stack, and the other end of the wind cover is tightly coupled with the system fan;
a display, which is configured on the second side of the fuel cell stack;
a circuit board, which is vertically fixed with the base, and configured on the third side of the fuel cell;
a condenser structure, which is configured on the fourth side and the upper surface of the fuel cell stack, and the inlet of the condenser structure is coupled with the system fan;
a condensing fan, which is tightly fixed with one side of the condenser structure;
a mixing tank, which is tightly coupled with the side of the condenser structure on the same side of the condensing fan, and the mixing tank is connected with the anode fuel inlet of the fuel cell stack and the condenser structure with pipes, respectively; and
a pump, which is tightly configured on one side of the mixing tank.

2. The fuel cell device according to claim 1, wherein the display is a compact liquid crystal display.

3. The fuel cell device according to claim 1, wherein the fuel cell stack is presented as a rectangular cylinder in appearance.

4. The fuel cell device according to claim 1, further comprises: at least one circuit component, in which the circuit components are configured on the circuit board, and the circuit components are electrically connected with the fuel cell stack.

5. The fuel cell device according to claim 1, further comprises: a connection interface, which is used as the output of the power generated by the fuel cell stack, and used to connect with an electronic device.

6. The fuel cell device according to claim 1, wherein the pump is connected between the mixing tank and an external fuel tank with pipes for pulling the fuel in the fuel tank into a first inlet of the mixing tank.

7. The fuel cell device according to claim 6, further comprises: a first pump, which is connected between the mixing tank and the fuel cell stack with pipes for pulling the fuel in the mixing tank into the anode fuel inlet of the fuel cell stack.

8. The fuel cell device according to claim 7, further comprises: a second pump, which is connected between the mixing tank and the condenser structure with pipes for pulling the condensing water generated from the condenser structure into a second inlet of the mixing tank.

9. The fuel cell device according to claim 8, wherein the anode fuel outlet of the fuel cell stack and the third inlet of the mixing tank are connected with pipes.

10. The fuel cell device according to claim 4, wherein the circuit components are used to establish a power management circuit.

11. The fuel cell device according to claim 5, wherein the electronic device is one of a notebook computer, a mobile phone, a personal digital assistant, and a portable electronic machine.

12. The fuel cell device according to claim 1, wherein the mixing tank is used to store a methanol aqueous solution.

13. The fuel cell device according to claim 6, wherein the external fuel tank is used to store a pure methanol.
